(19) United States
(12) Patent Application Publication
(10) Pub. No.: US 2025/0163708 A1
(43) Pub. Date: May 22, 2025

(54) PANEL FOR CONCRETE FORMWORK AND PRODUCTION METHOD THEREOF

(71) Applicant: ULMA C Y E, S. COOP., OÑATI (Gipuzkoa) (ES)

(72) Inventors: Ander OLLO ODRIOZOLA, ZUMARRAGA (Gipuzkoa) (ES); Manuel COLINO VEGA, VITORIA - GASTEIZ (ARABA/ÁLAVA) (ES); Alexandra ALLUE SALVADOR, ZAMUDIO (BIZKAIA) (ES); Joseba Koldo GONDRA ZUBIETA, ZAMUDIO (BIZKAIA) (ES)

(21) Appl. No.: 19/033,892

(22) Filed: Jan. 22, 2025

Related U.S. Application Data
(63) Continuation of application No. PCT/ES2023/070351, filed on May 29, 2023.

(30) Foreign Application Priority Data
Jul. 29, 2022 (EP) 22382733.8

(51) Int. Cl. E04G 9/02; B32B 5/02; B32B 5/26; B32B 27/12; B32B 27/20; B32B 27/38; B32B 27/42; B32B 37/24

(52) U.S. Cl. CPC E04G 9/02; B32B 5/024; B32B 5/263; B32B 27/12; B32B 27/20; B32B 27/38; B32B 27/42; B32B 37/24; B32B 2250/40; B32B 2262/101; B32B 2262/16; B32B 2264/1023; B32B 2272/00; B32B 2305/188; B32B 2305/22; B32B 2305/77; B32B 2307/718; B32B 2419/00

(57) ABSTRACT

A concrete formwork panel that includes a core and a reinforcement layer on at least one of the core. The reinforcement layer includes woven glass fiber. The core includes thermosetting polymer waste, a glass fiber filler, and a thermosetting resin, wherein the glass fiber filler is a glass fiber filler present in the thermosetting polymer waste, and/or a glass fiber filler apart from the thermosetting polymer waste.

### CROSS-REFERENCE TO RELATED APPLICATIONS

This application relates to and claims the benefit and priority to International Application No. PCT/ES2023/070351, filed May 29, 2023, which relates to and claims the benefit and priority to European Application No. EP22382733.8, filed Jul. 29, 2022, each of which is incorporated by reference herein in its entirety.

### FIELD

The present invention relates to panels for concrete formwork and to production methods thereof.

### BACKGROUND

Panels for concrete formwork typically comprise a wooden core conferring very good mechanical features upon them at a competitive price. Panels with the same features as typical panels with a wooden core are also known, comprising a polymer core and a reinforcement layer on at least one of the sides of the core.

EP1635010A1 discloses a panel for concrete formwork comprising a polymer core and optional layers on at least one face of the core. The polymer core comprises thermoplastic waste, specifically recycled polypropylene, combined with rubber waste.

### SUMMARY

Disclosed is a panel for concrete formwork and a production method thereof.

A first aspect of the invention relates to a panel for concrete formwork comprising a polymer core and a reinforcement layer on at least one of the sides of the core. The reinforcement layer comprises woven glass fiber. The core comprises thermosetting polymer waste, a glass fiber filler, and a thermosetting resin, wherein the glass fiber filler is a glass fiber filler present in the thermosetting polymer waste, and/or a glass fiber filler apart from the thermosetting polymer waste.

A second aspect of the invention relates to a production method of a structural panel such as the one described above, the method comprising the steps of:
a. grinding the thermosetting polymer waste,
b. mixing the thermosetting resin and the glass fiber filler apart from the thermosetting polymer waste with the ground thermosetting polymer waste,
d. forming the mixture by curing the thermosetting resin such that it acts as a binder of the ground thermosetting polymer waste and of the glass fiber filler in order to obtain the panel.

With the panel of the invention, an alternative to panels for concrete formwork with a wooden core, and also to panels with a core with thermoplastic waste, is obtained. The panel of the invention complies with the mechanical features required and allows the utilization of thermosetting polymer waste, which is difficult to recycle and highly contaminating.

These and other advantages and features of the invention will become apparent in view of the figures and the detailed description.

### BRIEF DESCRIPTION OF THE DRAWINGS

FIG. 1 is a sectioned front view of a panel according to a first embodiment.

FIG. 2 is a sectioned front view of a panel according to a second embodiment in a horizontal concrete formwork.

### DETAILED DESCRIPTION

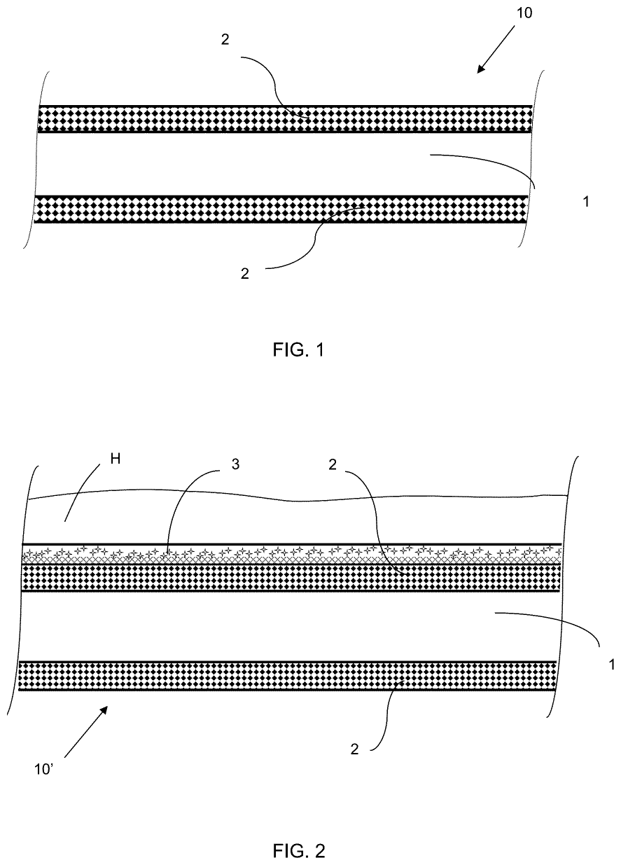

The panel 10; 10′ for concrete formwork of the invention comprises a polymer core 1 and a reinforcement layer 2 on at least one of the sides of the core 1, as shown in FIGS. 1 and 2. The reinforcement layer 2 comprises woven glass fiber, and the core 1 comprises thermosetting polymer waste, a glass fiber filler, and a thermosetting resin, wherein the glass fiber filler is a glass fiber filler present in the thermosetting polymer waste, and/or a glass fiber filler apart from the thermosetting polymer waste. In other words, the glass fiber filler in the core 1 is the sum of a glass fiber filler present in the thermosetting polymer waste and/or a glass fiber filler added to said thermosetting polymer waste during the production method of the panel.

In those cases where all the glass fiber filler is present in the thermosetting polymer waste, having to add an additional glass fiber filler which is apart from the thermosetting polymer waste to the thermosetting polymer waste is avoided, whereby reducing the raw material cost. In those cases where the glass fiber filler in the thermosetting polymer waste is residual, in addition to the thermosetting polymer waste, all the glass fiber filler of the core must be added separately. However, in most cases, a part of this is already present in the thermosetting polymer waste and the other part will have to be added separately. The percentage of the glass fiber filler apart from the thermosetting polymer waste that will have to be added will depend on the type of starting thermosetting polymer waste.

Instead of comprising thermoplastic waste, the core 1 comprises thermosetting polymer waste. In fact, the thermosetting polymer waste is preferably the main compound of the core with a majority percentage by weight.

The thermosetting polymer material is processed by means of hot curing in which polymer bonds are formed, acquiring rigidity. Thermosetting polymer waste is a tailing, remnant, or excess of thermosetting polymer material that is disposed of as it is cured, and it cannot be heated again and molded because it degrades, unlike thermoplastic waste, which can be molded and heated again as many times needed. Therefore, although the thermosetting polymer waste, like all polymer material waste, is contaminating because the decomposition thereof lasts for several generations, it is more difficult to recycle or be reused at a competitive cost.

To be able to reuse the thermosetting polymer waste, the ground thermosetting waste is mixed with the thermosetting resin. Regardless of the fact that the thermosetting polymer waste may comprise thermosetting resin, said thermosetting resin of the waste is not valid because it is in a cured or semi-cured state, where the panel of the invention requires a thermosetting resin that has not been previously cured to be able to act as a binder of the thermosetting polymer waste. The thermosetting resin of the core thereby acts as a binder of the ground thermosetting polymer waste and of the glass fiber filler when forming the core.

The panel of the invention for concrete formwork complies with the mechanical features required of formwork applications such as, for example, a flexural strength of at least 30 MPa and a flexural modulus of at least 3500 MPa. Said mechanical features in the panel of the invention are achieved particularly as a result of the glass fiber filler of the core and the woven glass fiber of the reinforcement layer.

The glass fiber filler is formed by glass fibers that are cut up and dispersed in the core. In contrast, in woven glass fiber, the glass fibers are interwoven with one another forming a single-layer bidirectional glass fiber fabric, or a multi-layer three-dimensional glass fiber fabric. Although the glass fiber improves the mechanical features at a relatively competitive prices compared to other fibers, the woven glass fiber provides even better mechanical features than the cut-up glass fiber.

With the panel of the invention, an alternative to panels for concrete formwork with a wooden core, and also to panels with a core with thermoplastic waste, is obtained. The panel of the invention complies with the mechanical features required and allows the utilization of thermosetting polymer waste, which is difficult to recycle and highly contaminating.

In a first embodiment shown in FIG. 1, the panel 10 comprises a reinforcement layer 2 on either side of the core 1 forming a sandwich type panel. A panel with better mechanical features which is easier to produce as a result of said symmetrical construction which traps the ground thermosetting polymer waste of the core between the reinforcement layers is thereby achieved.

The percentage by weight of the thermosetting resin can be between 5% and 15% of the weight of the core 1.

The thermosetting polymer waste preferably comprises epoxy and/or melamine waste. In other embodiments, the thermosetting polymer waste can comprise phenolic, ureic, or polyester waste, or a combination of the mentioned waste.

The total glass fiber filler in the core 1 is at least 30% of the weight of the core 1, preferably 40%. The higher the percentage by weight of the glass fiber filler, the better the mechanical features are obtained in the panel.

The glass fiber filler can be cut glass fiber yarns of a length between 5 mm and 35 mm, preferably between 10 mm and 15 mm. With said glass fiber length interval, a compromise between good mechanical features and production difficulty with good impregnation and dispersion thereof is sought.

The thermosetting resin is preferably a phenolic resin, which is very cost-competitive. The thermosetting resin can also be a melamine resin or a combination of phenolic resin and melamine resin.

The woven glass fiber of the reinforcement layer 2 can be pre-impregnated in a thermosetting resin, said thermosetting resin being of the same type as the thermosetting resin of the core 1. The fiber pre-impregnated in resin is also known as prepeg. It thereby allows the joint forming of the core 1 and the reinforcement layer 2 in a single forming process, and a panel with very good adhesion is obtained. In the joint forming step for forming the core 1 and the reinforcement layer 2, the thermosetting resin of the reinforcement layer 2, on one hand, acts as a binder of the woven glass fibers and, on the other hand, flows into the core 1 and is cured at the same time as the thermosetting resin of the core 1, and since both are resins of the same type, the core 1 and the reinforcement layer 2 are chemically bound to one another.

Preferably, the woven glass fiber of the reinforcement layer 2 is a polymer molding compound supplied in the form of a glass fiber-reinforced sheet, also known as GF-SMC, or glass fiber sheet molding compound.

The reinforcement layer 2 can have a basis weight of 60 to 1200 g/m2, preferably 60 to 200 g/m2. Although better mechanical features in the panel are achieved at a higher basis weight of the reinforcement layer 2, a basis weight of 60 to 200 g/m2 allows the required mechanical features to be achieved and the reinforcement layer 2 to be able to be formed together with the core 1 in a single forming step without requiring additional equipment for a second or third forming step.

In a second embodiment shown in FIG. 2, the panel 10′ comprises, in addition to the above-mentioned features, a finishing skin 3 on at least one reinforcement layer 2, said reinforcement layer 2 being the reinforcement face which is in contact with the cast concrete H, the finishing skin 3 comprising melamine resin and aluminum oxide particles. The aluminum oxide is preferably corundum. The panel 10′ thereby comprises on the face in contact with the cast concrete a non-slip smoothly finished surface with very good abrasion resistance. Said finishing skin is particularly advantageous in concrete formwork panels.

The basis weight of the reinforcement layer 2 for achieving the mechanical features required can be limited when forming the core 1 and the reinforcement layer 2 in a single forming cycle because a too high basis weight of the reinforcement layer 2 can hinder proper curing of the thermosetting resin of the core 1. Therefore, the finishing skin 3 preferably comprises a woven glass fiber mesh or a plurality of woven glass fiber meshes. The finishing skin 3 thereby provides part of the mechanical features to the panel 10′, allowing the basis weight in the reinforcement layer 2 to be reduced in order to achieve specific mechanical features or allowing better mechanical features to be achieved by maintaining the basis weight of the reinforcement layer 2.

Preferably, the woven glass fiber mesh of the finishing skin 3 has a basis weight equal to or less than 200 g/m2. The woven glass fiber mesh can thereby be well-impregnated in the melamine resin and, therefore, can be well-adhered to the finishing skin 2 and provide good flexural strength.

Preferably, the woven glass fiber mesh or the plurality of woven glass fiber meshes is arranged away from the contact face with the cast concrete H. It therefore does not affect the properties required of the contact face with concrete, such as a smooth finish, good resistance to wear, and chemical resistance.

Table 1 below shows the values of flexural modulus and flexural strength obtained in tests with a pair of example panels 10 according to the invention (Sample 1 and Sample 2).

TABLE 1

| | Sample 1 | Sample 2 |
|---|---|---|
| Core | 55% thermosetting | 55% thermosetting |
| | polymer waste/30% | polymer waste/30% |
| | glass fiber filler/15% | glass fiber filler/15% |
| | thermosetting resin | thermosetting resin |
| Reinforcement layer | on both sides, | on both sides, woven |
| | woven glass fiber | glass fiber |
| | prepeg 60 g/m² | prepeg 200 g/m² |
| Flexural modulus (MPa) | 3500 | 4000 |
| Flexural strength (MPa) | 40 | 40 |

A second aspect of the invention relates to a production method of a panel 10; 10′ such as those described above, the method comprising the steps of:
a. grinding the thermosetting polymer waste,
b. mixing the thermosetting resin and the glass fiber filler apart from the thermosetting polymer waste with the ground thermosetting polymer waste,
d. forming the mixture by curing the thermosetting resin such that it acts as a binder of the ground thermosetting polymer waste and of the glass fiber filler in order to obtain the panel.

Preferably, before forming the mixture, said mixture is placed on the reinforcement layer 2, with the core 1 being formed together with the reinforcement layer 2. A single forming step is thereby required to form the core and the reinforcement layer, and better adhesion between the core and the reinforcement layer is obtained in order to avoid delamination problems during use.

Furthermore, before forming the mixture, an additional reinforcement layer 2 can be placed on the mixture, with the core 1 being formed together with the two reinforcement layers 2 in order to produce sandwich type panels.

The method can comprise an additional forming step in which the finishing skin 3 is formed, and an attachment step after the additional forming step in which the finishing skin 3 is attached to at least one reinforcement layer 2 on which it is arranged by cold adhesion in order to produce panels comprising the finishing skin.

Preferably, constant temperature and pressure are applied in the forming step.

Although a panel for formwork in particular has been described, the panel according to the invention could also be used in other construction applications, such as in structural frames, baseboards, boards, ceilings, and floors, or any other application in construction requiring structural panels.

The features and/or aspects of the described panel are also valid and applicable to the production method and vice versa.

What is claimed is:

1. A concrete formwork panel comprising:
a core comprising thermosetting polymer waste, a thermosetting resin, and a glass fiber filler; and
a first reinforcement layer disposed on the first side of the core, the first reinforcement layer comprising a woven glass fiber that is pre-impregnated in a thermosetting resin that is of the same type of the thermosetting resin in the core.

2. The concrete formwork panel according to claim 1, wherein the glass fiber filler is a glass fiber filler present in the thermosetting polymer waste.

3. The concrete formwork panel according to claim 1, further comprising a second reinforcement layer disposed on a second side of the core, the second side of the core being opposite the first side of the core.

4. The concrete formwork panel according to claim 1, wherein the thermosetting polymer waste comprises an epoxy and/or melamine waste.

5. The concrete formwork panel according to claim 1, wherein the glass fiber filler is cut glass fiber yarns of a length between 5 millimeters and 35 millimeters.

6. The concrete formwork panel according to claim 1, wherein the glass fiber filler is cut glass fiber yarns of a length between 10 millimeters and 15 millimeters.

7. The concrete formwork panel according to claim 1, wherein a percentage by weight of the thermosetting resin is between 5% and 15% of a weight of the core.

8. The concrete formwork panel according to claim 1, wherein a percentage by weight of the glass fiber filler in the core is at least 30% of the weight of the core.

9. The concrete formwork panel according to claim 1, wherein a percentage by weight of the glass fiber filler in the core is at least 40% of the weight of the core.

10. The concrete formwork panel according to claim 1, wherein the thermosetting resin in the core is a phenolic resin.

11. The concrete formwork panel according to claim 1, wherein the first reinforcement layer is a polymer molding compound in the form of a glass fiber-reinforced sheet.

12. The concrete formwork panel according to claim 1, wherein the first reinforcement layer has a basis weight of 60 to 1200 g/m².

13. The concrete formwork panel according to claim 1, wherein the first reinforcement layer has a basis weight of 60 to 200 g/m².

14. The concrete formwork panel according to claim 1, further comprising a finishing skin disposed on the first reinforcement layer, the finishing skin comprising melamine resin and aluminum oxide particles.

15. The concrete formwork panel according to claim 14, wherein the finishing skin comprises a woven glass fiber mesh or a plurality of woven glass fiber meshes.

16. The concrete formwork panel according to claim 15, wherein the woven glass fiber mesh of the finishing skin has a basis weight equal to or less than 200 g/m².

17. A method of forming a concrete formwork panel according to claim 1, the method comprising:
granulating the thermosetting polymer waste;
forming a mixture by mixing together the thermosetting resin, the glass fiber filler and the granulated thermosetting polymer waste, and
curing the thermosetting resin in the mixture to bind the thermosetting polymer waste and the glass fiber filler to obtain the core.

18. The method according to claim 17, wherein the curing of the thermosetting resin occurs at a constant temperature and at a constant pressure.

19. A method of forming a concrete formwork panel according to claim 1, the method comprising:
granulating the thermosetting polymer waste;
creating a mixture by mixing together the thermosetting resin, the glass fiber filler and the granulated thermosetting polymer waste for the purpose of forming the core, and
curing the thermosetting resin in the mixture to bind the thermosetting polymer waste and the glass fiber filler to obtain the core and simultaneously curing the thermosetting resin in the first reinforcement layer to form the concrete formwork panel.

20. The method according to claim 19, wherein the curing of the thermosetting resin in the mixture and the curing of the thermosetting resin in the first reinforcement layer occurs at a constant temperature and at a constant pressure.
